(19) United States
(12) Patent Application Publication
(10) Pub. No.: US 2024/0350334 A1
(43) Pub. Date: Oct. 24, 2024

(54) SECURING A PERSON WITH REDUCED MOBILITY DEVICE IN A SEATING AREA

(71) Applicant: Delta Air Lines, Inc., Atlanta, GA (US)

(72) Inventors: Sean Vincent Lopes, Falls Church, VA (US); Mitchell Rife, Hampton, GA (US); Andrew James Baker, Winston, GA (US); John Patrick O’Keefe, JR., Atlanta, GA (US)

(21) Appl. No.: 18/537,333

(22) Filed: Dec. 12, 2023

Related U.S. Application Data
(60) Provisional application No. 63/496,803, filed on Apr. 18, 2023.

(51) Int. Cl. A61G 3/08

(52) U.S. Cl. CPC A61G 3/0808

(57) ABSTRACT

Securing a person with reduced mobility (PRM) device in a seating area is provided. More specifically, a securing apparatus includes a base plinth and a latching mechanism. The base plinth has at least one cavity and configured to be mounted with a track fitting for securing at least one seat thereon. The at least one seat includes a seatback and a base that is foldable against the seatback to accommodate a person with reduced mobility (PRM) device. The latching mechanism is in the at least one cavity of the base plinth and is configured to secure the PRM device to the base plinth when the PRM device is positioned proximate to the seatback and on the base plinth.

### CROSS-REFERENCE TO RELATED APPLICATION

This application claims the benefit of priority under 35 U.S.C. § 119 (e) to U.S. Provisional Patent Application No. 63/496,803, entitled “MECHANISM FOR SECURING A WHEELCHAIR IN AN AIRCRAFT SEATING AREA,” filed on Apr. 18, 2023, which is hereby incorporated by reference in its entirety.

### BACKGROUND

A person with reduced mobility (PRM) who uses a wheelchair may sometimes need seating accommodations, such as in public transportation vehicles (trains, airplanes, buses, etc.). Most airplanes do not have the needed accommodations for a wheelchair, scooter, stroller, etc. As a result, these items or devices are stored in separate baggage areas and may become lost or damaged. There is associated financial loss to the carrier to replace or repair damaged wheelchairs. In addition, the PRM may not be able to function without their wheelchair. Further, it is inconvenient and sometimes nearly impossible or very difficult for the PRM to transfer into an airplane seat.

### BRIEF DESCRIPTION OF THE DRAWINGS

FIG. 1 is a diagram illustrating a seating apparatus that includes a PRM securing apparatus that secures a PRM device in an aircraft, according to an example embodiment.

FIG. 2 is a diagram depicting a PRM securing apparatus for securing a PRM device in a seating area of an aircraft, according to an example embodiment.

FIG. 3 is a diagram illustrating components of the latching mechanism for securing the PRM device to a plinth, according to an example embodiment.

FIG. 4 is a diagram illustrating the latching mechanism being partially deployed for attaching to a PRM device placed in a seating area of an aircraft, according to an example embodiment.

FIG. 5 is a view illustrating a PRM device of FIG. 1 being secured in a seating area of the aircraft using the PRM securing apparatus, according to an example embodiment.

FIG. 6 is a block diagram illustrating a PRM seat securing apparatus for securing a PRM device, according to another example embodiment.

FIG. 7 is a diagram illustrating a motion assembly of a latching mechanism for securing the PRM device to a base plinth, according to another example embodiment.

FIG. 8 is a diagram illustrating a bottom surface of a base plinth of FIG. 6 to which a PRM device is secured, according to another example embodiment.

FIG. 9 is a flowchart illustrating a method of securing a PRM device in a seating area, according to an example embodiment.

### DESCRIPTION OF EXAMPLE EMBODIMENTS

### Overview

Briefly, a system, a method, and an apparatus are provided for securing a PRM device in a seating area of an aircraft.

More specifically, in one form, a securing apparatus is provided. The securing apparatus includes a base plinth and a latching mechanism. The base plinth has at least one cavity and is configured to be mounted with a track fitting for securing at least one seat thereon. The seat includes a seatback and a base that is foldable against the seatback to accommodate a person with reduced mobility (PRM) device. The latching mechanism is in the at least one cavity of the base plinth and is configured to secure the PRM device to the base plinth when the PRM device is positioned proximate to the seatback and on the base plinth.

In another form, a seat securing apparatus is provided. The seat securing apparatus includes a seat, a base plinth, and a latching mechanism. The seat has at least one leg, a seatback, and a base that is foldable against the seatback to accommodate a PRM device. The base plinth has at least one first cavity configured to accommodate the at least one leg of the seat and at least one second cavity and the latching mechanism placed at the at least one second cavity. The latching mechanism is configured to secure the PRM device to the base plinth when the PRM device is positioned proximate to the seatback and on the base plinth.

In yet another form, a method for securing a PRM device is provided. The method includes positioning a PRM device onto a base plinth having at least one cavity and configured to be mounted with a track fitting for securing a seat of a passenger. The seat includes a seatback and a base that is foldable against the seatback. The method further includes securing the PRM device to the base plinth using a latching mechanism in the at least one cavity when the PRM device is positioned proximate to the seatback and on the base plinth.

### Example Embodiments

It is not unusual for a PRM to avoid public or private spaces that lack special accommodations for their PRM devices. PRM devices aid transport or movement of a person. The PRM devices come in a variety of sizes and formats to meet specific needs of their users. For example, the PRM devices include but are not limited to wheelchairs, strollers, scooters, etc.

While some seating areas have space to accommodate the PRM device, the PRM device needs to be securely fastened or anchored in the seating area, especially in a moving vehicle such as an aircraft. Aircrafts are subjected to different test criteria and safety regulatory compliance requirements for fastening mechanisms in comparison to automotive transportation requirements. For example, passengers experience takeoff, landing, and may encounter turbulence in-flight and the fastening mechanisms used in an aircraft need to account for this. However, securing a PRM device in an aircraft is particularly challenging because typical flooring of an aircraft is not strong enough or otherwise configured for securing the PRM device. As such, there is no securing system for a wheelchair to be used as an in-flight seat during aviation and air travel.

Typical securing systems used in other transit applications (buses, trains, cars) are not sufficient and cannot be applied to the aerospace sector. Additionally, other seating concepts reduce the number of passengers carried by an aircraft (PAX count of the cabin) or require a special wheelchair designed for use in in-flight, which would require the user to transfer into the special wheelchair.

A securing system is needed that would allow passengers to bring their own wheelchairs aboard the aircraft without compromising seating space (PAX count) and/or the safety for these PRM passengers. The securing system needs to be adaptable to various PRM devices without reducing the PAX count. To avoid reducing the PAX count, the seating area needs to be adjustable to accommodate a seat for a passenger and to accommodate a PRM device instead of the seat.

In one or more example embodiments, a PRM securing system or apparatus is provided for securing a PRM device in a seating area of an aircraft. The PRM securing system may be used in a seating area instead of a typical or standard aircraft seat without compromising the PAX count. For example, a common design for accommodating a wheelchair involves removing or lifting the seat cushion of a standard aircraft seat to an upright position (placing the seat cushion against a seatback) to make room for the PRM device in the seating area. To address the challenges noted above with respect to securing the PRM device in an aircraft seating area, a PRM device securing apparatus or a seat securing apparatus is provided. The PRM device securing apparatus or the seat securing apparatus does not interfere with the mounting of a standard passenger seat while also complying with the requirements and safety regulations of Federal Aviation Administration (FAA), which are different from the automotive transportation requirements.

In one or more example embodiments, the securing apparatus includes a base plinth that is mounted with a track fitting such that it does not interfere with the mounting of a standard passenger seat. For example, the base plinth includes seat leg cavities that accommodate seat legs of a standard passenger seat. Further, the base plinth includes cavities or space for a latching mechanism that is configured to secure the PRM device to the base plinth. As such, the seating space or area is adjusted to accommodate and secure the PRM device while not interfering with its use by a regular passenger instead of the PRM device. The latching mechanism may be hidden in one or more cavities in the base plinth when the seat is used as a standard passenger seat. In another example embodiment, the latching mechanism is positioned at the peripheral portions of the base plinth so as not to interfere with the use of the seating area by a passenger i.e., when it is used as a standard passenger seat. The latching mechanism is deployed and released (e.g., from the one or more cavities) when the seat base is folded against the seatback and the PRM device is positioned proximate to the seatback and on the base plinth.

While example embodiments described below relate to an aircraft seating area i.e., an aircraft seat, the disclosure is not limited thereto and is applicable to other settings or places, especially in which securing a PRM device may be challenging, such as but not limited to vehicles, amusement rides, theaters, auditoriums, stadiums, etc. The PRM securing system is configured to accommodate different types of the PRM devices including but not limited to PRM devices compliant with “Wheelchairs Used as Seats in Motor Vehicles” (WC-19) standard i.e., WC-19 rated wheelchairs. The PRM securing system enables PRM passengers to use their own PRM devices as a chair in-flight.

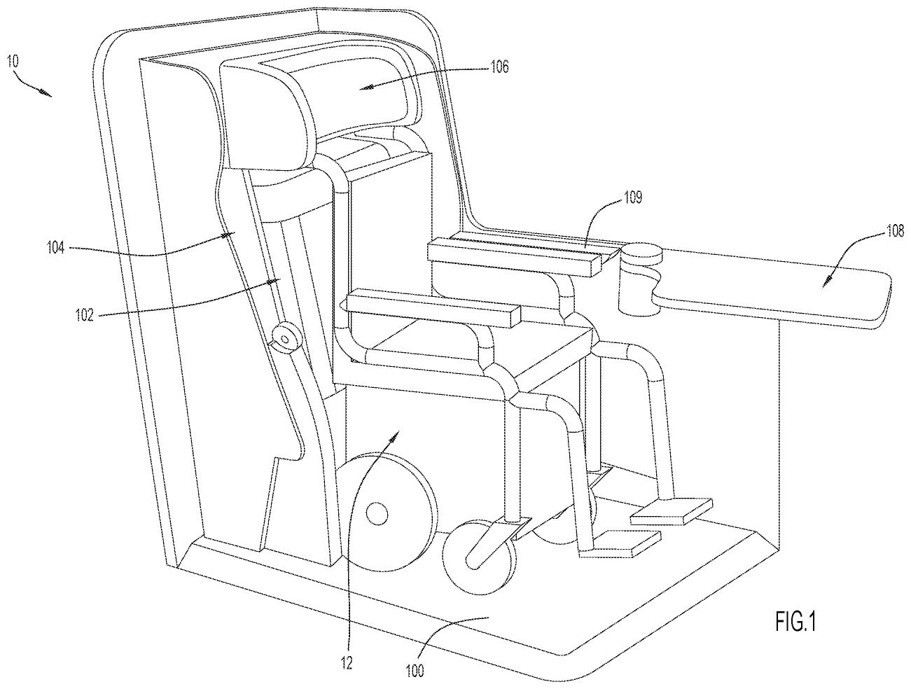

FIG. 1 is a diagram illustrating a seating apparatus 10 that includes a PRM securing apparatus 100 that secures a PRM device 12 in an aircraft, according to an example embodiment. The seating apparatus 10 has a base 102, a seatback 104, a headrest 106, and a tray table 108 attached to a console 109, and the PRM securing apparatus 100.

The tray table 108 is a non-limiting example of a console-based feature. Other console-based features may include a cup holder, a magazine holder, a book holder, media controls. In one example embodiment, the console 109 may be without any console-based features e.g., an armrest or a divider.

The base 102 is foldable against the seatback 104 but the disclosure is not limited thereto. For example, the base 102 may include a frame and a removable cushion (not shown). To accommodate the PRM device 12, the cushion is removed and the frame of the base 102 is stowed against the seatback 104. In FIG. 1, the base 102 is folded and stowed against the seatback 104 to accommodate the PRM device 12. In one example embodiment, the seatback 104 may have a removable cushion (not shown). When the cushion is removed, it creates a space for stowing away the base 102 when the base 102 is folded and pressed against the seatback 104. In yet another example embodiment, the seatback 104 may have an integrally formed cushion such that when the base 102 is folded against the seatback 104 (i.e., stowed), the base 102 protrudes with respect to the seatback 104.

Various aspects of the seating area may be configured to be adjusted to accommodate the PRM device 12 i.e., for use by a user in the PRM device 12 when the PRM device 12 is positioned proximate to the seatback 104. For example, the headrest 106 and the tray table 108 along with the console 109 may be adjustable to various positions (up and down and/or forward and aft) to accommodate a user in the PRM device 12.

In one or more example embodiment, the PRM securing apparatus 100 is configured to secure the PRM device 12 when the PRM device 12 is positioned proximate to the seatback 104. The PRM securing apparatus 100 includes a plinth and a latching mechanism. The PRM securing apparatus 100 may further include a cover that hides the plinth and the latching mechanism from view such that the seating apparatus 10 appears as a standard passenger seat. The PRM securing apparatus 100 may also position the latching mechanism at a periphery of the plinth e.g., underneath the seatback 104 to hide the latching mechanism from view and so that it does not interfere when the seating apparatus 10 is used as a standard passenger seat.

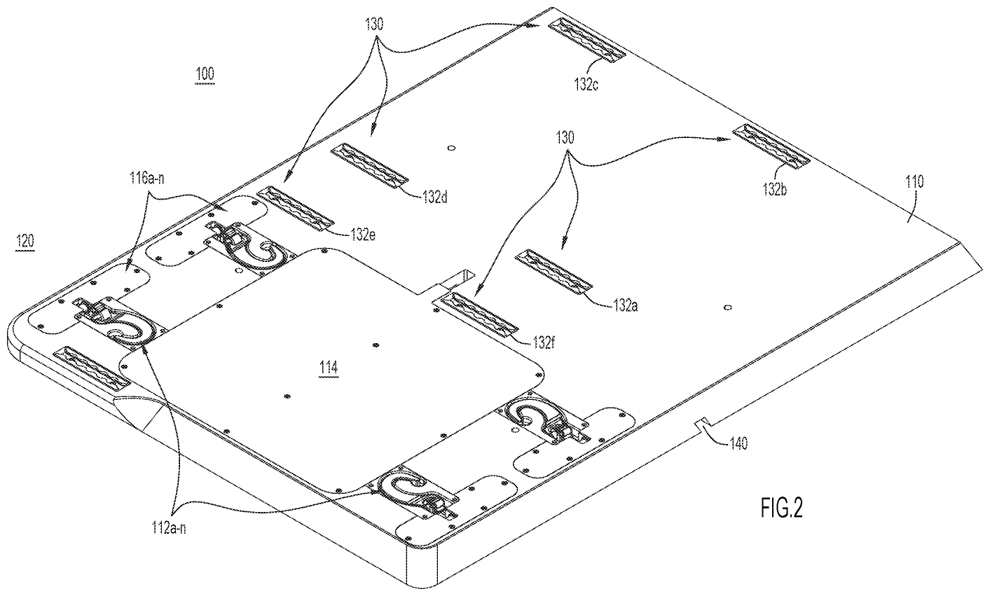

FIG. 2 is a diagram depicting a PRM securing apparatus 100 for securing a PRM device in a seating area of an aircraft, according to an example embodiment. The PRM securing apparatus 100 includes a plinth 110 that stores a latching mechanism 120 therein and includes seat track 130 having multiple track fittings 132a-f for securing passenger seats thereon and a wiring cavity 140.

The notations 1, 2, 3, . . . n; a, b, c, . . . n; “a-n”, “a-d”, “a-f”, “a-g”, “a-k”, “a-c”, and the like illustrate that the number of elements can vary depending on a particular implementation and is not limited to the number of elements being depicted or described. Moreover, this is only examples of various components, and the number and types of components, functions, etc. may vary based on a particular deployment and use case scenario.

The plinth 110 may be considered a support plate, a board, or a specialized fortified flooring panel. The plinth 110 includes a metal base specifically designed to accommodate the latching mechanism 120. Typically, standard passenger seats are mounted on seat tracks that run throughout the length of an aircraft. The seat tracks are not flooring and cannot support anchoring PRM devices thereto at least because the PRM devices are heavier than the standard passenger seats and lack components to attach to the seat tracks.

The plinth 110 is a false floor that is dedicated to securing a PRM device in the seating area. The plinth 110 also provides the ability to locate the seat legs as needed to accommodate no loss of PAX count due to the wheelchair only needing to take up one PAX. The plinth 110 may be configured to be mounted with the seat track 130 having multiple track fittings 132a-f for securing legs of passenger seats thereon. The plinth 110 is configured not to interfere with the mounting of seat legs to secure the passenger seats. In one or more example embodiments, the plinth 110 may further include a cover that hides the latching mechanism 120 when it is not deployed.

As such, the plinth 110 is configured to allow the seating area to service a dual purpose. The seating area accommodates a standard passenger seat in a first position when the base of the seat is unfolded and the latching mechanism 120 is stored within the plinth 110. That is, in the first position, the seating area appears as a standard passenger seat in the aircraft. The seating area accommodates the PRM device in a second position. In the second position, the base of the seat is folded against the seatback and the PRM device is proximate to the seatback and is secured to the plinth 110 i.e., using the latching mechanism 120.

In one example embodiment, a standard passenger seat is mounted or fastened to the plinth 110. In yet another example embodiment, the plinth 110 is designed so as not to interfere with the mounting of the standard passenger seat onto the seat track 130. The plinth 110 may be an aluminum and/or a composite panel and may include a seat track 130 mounted with track fittings 132a-f that permits the plinth 110 to transfer the loading of the seat and the PRM device (e.g., the wheelchair) into the plinth-mounted tracks, which in turn transfer the load to the plinth 110, which in turn transfers the load directly to an aircraft seat tracks.

In one example embodiment, the plinth 110 is configured to accommodate a single aircraft seat and has the dimension of approximately 43 inches by 55 inches, by way of a non-limiting example only. In this case, the plinth 110 includes a plurality of seat leg cavities (e.g., 2 or 4 depending on the seat) that secure the plurality of seat legs of a single aircraft seat to the aircraft seat track.

In another example embodiment, the plinth 110 may accommodate an aisle of seats or even across an aisle and connect two aisle seats. In yet another example embodiment, a pallet may be used that spans aft in the aircraft and connects multiple rows of seats on the same side. In other words, the plinth 110 may be a pallet that spans multiple rows of seats. In this case, the plinth 110 includes the plurality of seat leg cavities (e.g., over 4) for securing the plurality of passenger seats to the track fitting.

The plinth 110 may be of varied shapes. In one example embodiment, the plinth 110 may have a rectangular or square shaped such that the latching mechanism 120 is positioned at each corner of the plinth 110. In yet another example embodiment, the plinth 110 may have a circular shape or a triangular shape. The shape of the plinth 110 may vary depending on a particular use case scenario e.g., type of the PRM device to accommodate. For example, for a handicap scooter or mobility scooter, a triangular-shaped plinth may be used, whereas for a wheelchair, a rectangular-shaped plinth may be used.

The plinth 110 further includes a plurality of cavities 112a-n specifically designed to accommodate the latching mechanism 120. The plurality of cavities 112a-n may be on a top surface of the plinth 110. The plurality of cavities 112a-n include a first cavity (i.e., covered by a cover 114 in FIG. 2). The first cavity is configured to store therein multiple spring-loaded windings. In one example embodiment, a plurality of first cavities may be provided. Each first cavity for a respective spring-loaded winding and/or motor that drives the respective spring-loaded winding. The dimensions of the first cavity(s) depends on a particular deployment and use case scenario. For example, the depth, size, and shape of the first cavity is specific or dedicated to the spring-loaded winding(s) that are stowed therein.

The first cavity(s) that accommodates the components that allow movement of the mounting hooks is covered by the cover 114 e.g., a metal plate or a fortified board. The cover 114 is securely attached to the plinth 110 to cover the cavity or cavities underneath. The size of the cover 114 may serve as an indicator for the placement of the PRM device. That is, the PRM device is to be placed on the cover 114 where the hook cavities are positioned approximately near of the four corners of the cover 114. That is, the latching mechanism 120 is configured to secure the PRM device when the PRM device is fully placed on or centered on the cover 114.

The plurality of cavities 112a-n may further include a set of second cavities. Each second cavity stores a respective mounting hook. A first portion of the second cavity that stores the respective mounting hook may be open to allow the release and retraction of the mounting hook. While the second portion of the second cavity that connects the mounting hook to a cable or belt of the spring-loaded winding may be covered with a respective cover of a plurality of covers 116a-n. In one example embodiment, a second cavity that stores a mounting hook may be an open cavity to allow retraction of a hook of the latching mechanism 120.

Since the seating area is configured to be adjusted between the first position in which it is used as a standard passenger seat and the second position in which it accommodates the PRM device, the plinth 110 is configured to hide the latching mechanism 120. That is, the PRM securing apparatus 100 includes the pluralities of cavities 112a-n, the cover 114, and the plurality of covers 116a-n to minimize inconvenience when the seat is used as the standard passenger seat and to allow secure and reliable fastening of the PRM device when the PRM device is positioned proximate to the seatback.

The latching mechanism 120 i.e., a wheelchair retention mechanism, is nested inside the plinth 110 i.e., in the plurality of cavities 112a-n. The latching mechanism 120 holds the PRM device in a flight position for the seated passenger. The latching mechanism 120 anchors various types and sizes of the PRM devices. That is, the latching mechanism 120 may include two or more mounting hooks that are independently adjustable via a respective motion assembly to accommodate different types of PRM devices. The latching mechanism 120 securely fastens the PRM device in compliance with the requirements and safety regulations of the FAA.

The plinth 110 includes the seat track 130 with multiple track fittings 132a-f for securing passenger seats thereon. The multiple track fittings 132a-f may include a first track fitting 132a, a second track fitting 132b, a third track fitting 132c, a fourth track fitting 132d, and a fifth track fitting 132e and a sixth track fitting 132f.

The plinth 110 may further include the wiring cavity 140. The wiring cavity 140 may be a trench on a bottom surface of the plinth 110. The wiring cavity 140 is configured to accommodate one or more wirings for the respective passenger seat such as power, video, audio, electric adjustment, or other electronic related wirings.

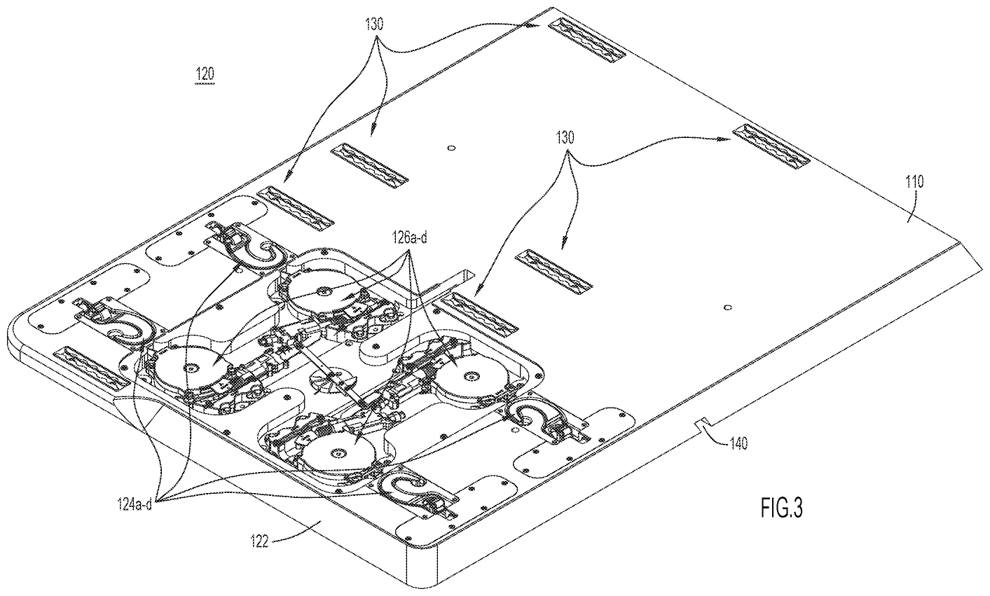

With continued reference to FIG. 2, FIG. 3 is a diagram illustrating components of the latching mechanism 120 for securing the PRM device to the plinth 110, according to an example embodiment. The latching mechanism 120 includes a hook release button 122, a plurality of mounting hooks 124a-d, and respective hook release and retract assemblies 126a-d.

The hook release button 122 may be a button that a user presses to actuate the respective hook release and retract assemblies 126a-d. The hook release button 122 may be a lever configured to be pressed with a foot of a user. The hook release button 122 may be configured to be automatically activated when the PRM device is properly positioned on the cover 114 (the metal plate). The hook release button 122 may include a plurality of hook release buttons, each for a respective mounting hook.

In one example embodiment, the hook release button 122 activates the respective hook release and retract assemblies 126a-d at substantially same time or synchronously. That is, by using the hook release button 122, an actuator is initiated that is configured to control motion assemblies (i.e., the release and retract assemblies 126a-d) to synchronously move the mounting hooks 124a-d towards respective latching points on the PRM device (not shown).

In yet another example embodiment, a plurality of release buttons are provided such that an individual release button activates a single motion assembly. An actuation component is configured to control the motion assemblies to release or retract the mounting hooks 124a-d, independently. Independently controlling the mounting hooks 124a-d aids in securing different types of PRM devices. Since the mounting hooks 124a-d are independently adjustable via respective motion assemblies, different types of PRM devices are properly secured.

In one example embodiment, while the hook release button 122 is pressed, the plurality of mounting hooks 124a-d are freely movable i.e., easily pullable and extendable, to be latched onto the PRM device. When the hook release button 122 is released, the plurality of mounting hooks 124a-d are retracted and tightened to secure the PRM device in place on the cover 114 (metal plate) of FIG. 2.

For example, when a release lever is pushed, it is in an unlocked position in which a core of a motion assembly freely pivots extending the spring-loaded winding towards a respective latching point on the PRM device. When the release lever is released, it goes into a locked position in which the spring-loaded winding is retracted to a predetermined tension point in which the respective mounting hook is latched onto the respective latching point on the PRM device to secure the PRM device to the plinth 110. The predetermined tension point depends on a particular deployment and use case scenario. In an aircraft, the predetermined tension point is sufficient to allow the PRM device to withstand the force of gravity 16 times i.e., to become a 16G airline seat. In one example embodiment, the hook release button 122 may be an electrical button that electrically actuates motors of the hook release and retract assemblies 126a-d for releasing and/or retracting the plurality of mounting hooks 124a-d.

The hook release button 122 may be located on a seating frame such that it is reachable by a PRM passenger when the PRM device is positioned in the seating area (on the cover 114 of FIG. 2). In another example embodiment, the hook release button 122 may be positioned on the plinth 110 such that it is activatable by the PRM device being positioned on the cover 114 of FIG. 2 or with an assistance from a flight attendant or another user, for example. In yet another example embodiment, the plinth 110 may include a plurality of sensors that detect presence of the PRM device on the metal plate (the cover 114 of FIG. 2) and send a signal to an actuator to place the release lever in the unlocked position.

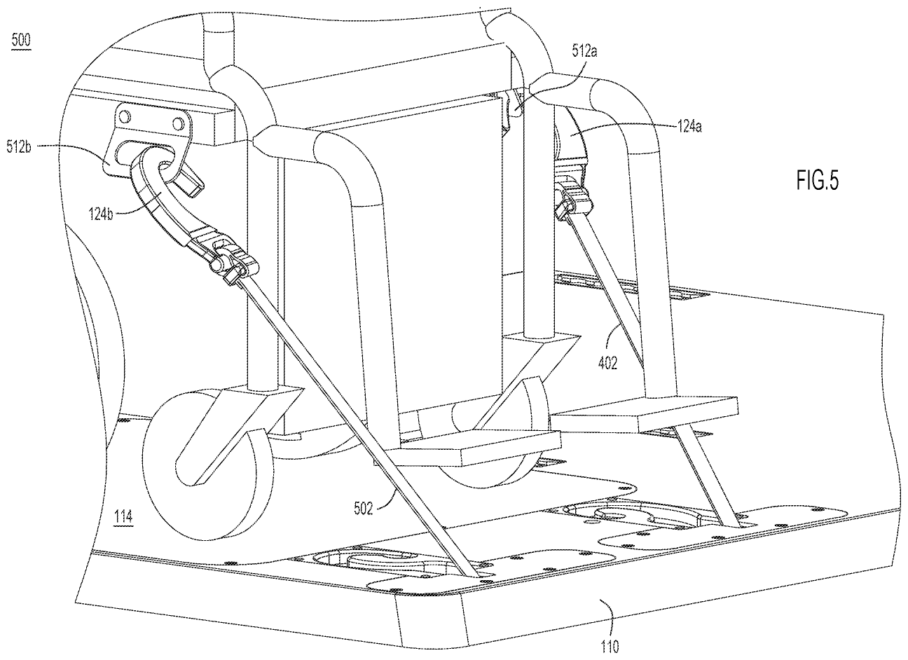

The plurality of mounting hooks 124a-d are stowed in respective captivities 112a-n of FIG. 2. The plurality of mounting hooks 124a-d attach to respective latching points on a PRM device e.g., to latching points designated in WC-19 standard, shown in FIG. 5.

Each of the hook release and retract assemblies 126a-d (motion assemblies) releases a respective mounting hook so that it is pulled out as needed to attach to the PRM device. Once the respective mounting hook is attached, each of the hook release and retract assemblies 126a-d retracts or tightens the respective mounting hook that is now attached or latched onto the PRM device. The retraction occurs to a predetermined tension point, which may be mechanically controlled by the spring of the spring-loaded winding.

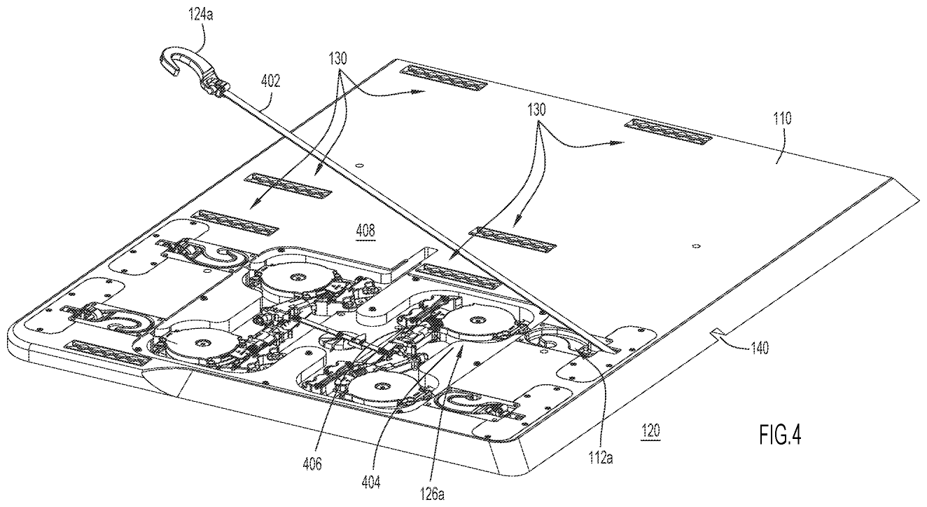

With continued reference to FIGS. 2 and 3, FIG. 4 is a diagram illustrating the latching mechanism 120 being partially deployed for attaching to a PRM device placed in a seating area of an aircraft, according to an example embodiment. Specifically, a first mounting hook 124a is released and is freely movable to latch onto a respective latching point on the PRM device. The first mounting hook 124a is released and retracted using a first hook release and retract assembly 126a (motion assembly). The first hook release and retract assembly 126a includes a spring-loaded winding. The spring-loaded winding includes belt 402 (e.g., a metal cable) that is wound around a core 404, an individual release lever 406, and a spring 408.

The first mounting hook 124a is nested in a first cavity 112a of the plinth 110. When the hook release button 122 of FIG. 3 is activated, the first mounting hook 124a is extended outside the first cavity 112a towards a respective latching point on a PRM device. The individual release lever 406 is pushed into an unlocked position in which the potential energy of the spring 408 is released. In one example embodiment, an actuator (not shown) may push the individual release lever 406 into the unlocked position at substantially same time as other levers of the other hook release and retract assemblies (motion assemblies). The core 404 pivots or rotates freely such that the belt 402 is pulled out or extended as needed (either mechanically or electrically with an aid of a motor, not shown).

The first mounting hook 124a is latched onto a respective latching point on the PRM device. When the individual release lever 406 is released, it is in the locked position. The spring 408 in the center of the core 404 may be a rotary spring that causes the core 404 to rotate and retract the belt 402 to an appropriate tension point.

With continued reference to FIGS. 2-4, FIG. 5 is a view illustrating a PRM device 12 of FIG. 1 being secured in a seating area 500 of the aircraft using the PRM securing apparatus 100, according to an example embodiment. The seating area 500 includes a PRM device 12 e.g., a wheelchair.

In the seating area 500, the first mounting hook 124a and a second mounting hook 124b are attached to a first latching point 512a and a second latching point 512b of the PRM device 12, respectively. The belt 402 and a second belt 502 are retracted to a predetermined tension point by respective hook release and retract assemblies nested within the plinth 110. As such, the PRM device 12 is anchored in place on the cover 114.

In one or more example embodiments, when the hook release button 122 is pressed, the plurality of mounting hooks 124a-d are pulled out, using the respective belts, at a length required to be latched onto the PRM device 12. When the hook release button 122 is released, the hook release and retract assemblies 126a-d automatically tighten the belts back down, leaving the plurality of mounting hooks 124a-d tightly secured on the respective latching points of the PRM device 12.

The retractable belt-mounted hooks are stored or nested in the plinth 110. The motion assemblies automatically release and retract the belts using either a mechanical or electro-mechanical release mechanisms to allow the mounting hooks to be deployed. The PRM securing apparatus 100 retains the PRM device 12 such as a wheelchair for use in-flight, meeting accepted criteria established by the FAA. The seating area 500 may be certified against technical standard orders (TSO)-C127c for typical passenger and mass retention for PRM configurations.

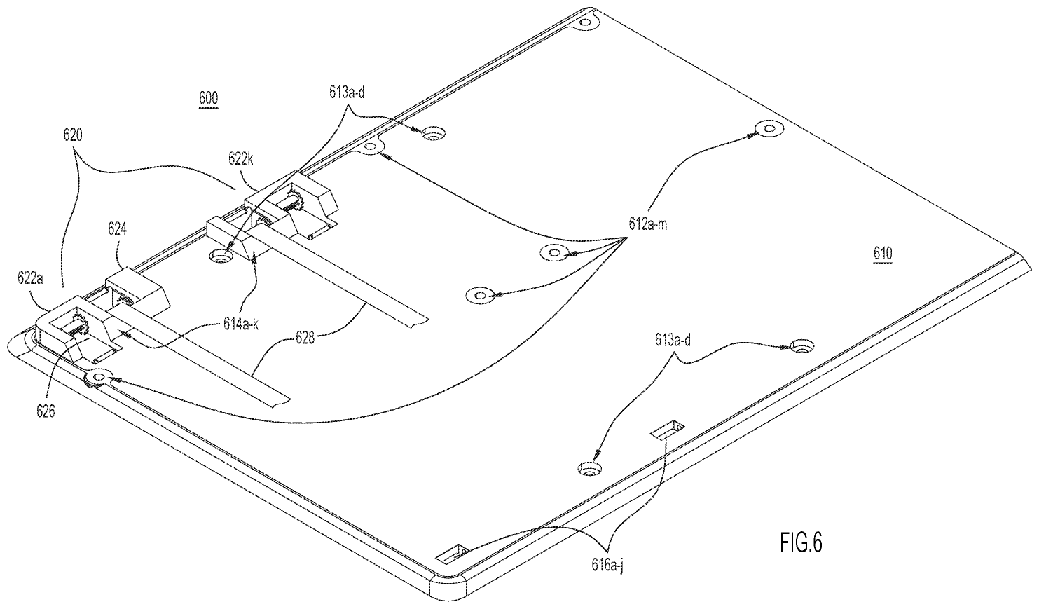

FIG. 6 is a block diagram illustrating a PRM seat securing apparatus 600 for securing a PRM device, according to another example embodiment. The PRM seat securing apparatus 600 includes a base plinth 610 and a latching mechanism 620.

Unlike the plinth 110 of FIGS. 2-5, the base plinth 610 is substantially thinner e.g., it may be a few inches in thickness. By decreasing the height of the base plinth 610, in comparison to the plinth 110, it is easier for the PRM device e.g., a wheelchair, to access or roll onto the base plinth 610. The height of the base plinth 610 may be reduced by about 25% in comparison to the plinth 110.

The base plinth 610 includes a plurality of seat leg cavities 612a-m, a plurality of aircraft seat track fitting mounting cavities 613a-d, and a plurality of latching cavities 614a-k. The plurality of seat leg cavities 612a-m are uniquely positioned to accommodate or make room for the PRM device. The plurality of seat leg cavities 612a-m are positioned so as not to interfere with the placement of the PRM device such as the wheelchair. The plurality of aircraft seat track fitting mounting cavities 613a-d are cavities for securing the base plinth to the seat tracks. The plurality of latching cavities 614a-k are configured to accommodate the latching mechanism 620.

Specifically, the plurality of latching cavities 614a-k are configured to provide space for positioning a portion of the latching mechanism 620 (e.g., core winding(s)). The plurality of latching cavities 614a-k may further include slots 616a-j for respective belts of the latching mechanism 620. Of course, this is just one non-limiting example embodiment of the plurality of latching cavities 614a-k. The number, shape, and type of the plurality of latching cavities 614a-k may vary based on a particular deployment and use case scenario. In one or more example embodiments, the latching mechanism 620 may protrude from the plurality of latching cavities 614a-k.

Unlike the latching mechanism 120 of FIGS. 2-5, the latching mechanism 620 is positioned at the back of the base plinth 610. This location may help reduce the height of the base plinth 610 i.e., by not having cavities that fully store the latching mechanism within. Since the latching mechanism 620 is moved out of the way so as not to interfere with the seating area being used as a standard passenger seat and the positioning of the PRM device, the latching mechanism 620 need not be fully stored in the plurality of latching cavities 614a-k and may protrude therefrom.

The latching mechanism 620 is configured to release and retract and latch onto a PRM device in an analogous manner to the latching mechanism 120 of FIGS. 2-5. However, the latching mechanism 620 uses horizontal rotation axis instead of the vertical rotation axis of the latching mechanism 120 of FIGS. 2-5.

In one example embodiment, the latching mechanism 620 may be positioned on a periphery or outer edges of the base plinth 610, which also avoids any interference with the use of the seating space by a passenger in the first position and the PRM device in the second position. For example, the latching mechanism 620 may be positioned under the seat base next to rear seat leg(s).

The latching mechanism 620 include motion assemblies 622a-k such as a first motion assembly 622a and a second motion assembly 622k. Each of the motion assemblies 622a-k includes a housing 624 e.g., a protruding support frame. The housing 624 is configured to protect the motion assemblies from damage by elements in an environment e.g., the PRM device, a passenger, etc. The housing 624 protrudes from the base plinth 610 by an inch or more, for example. The housing 624 is configured to protect two or more retractors therein and may be s-shaped but this is just a non-limiting example. The housing 624 may assume various forms and may house one or more retractors therein depending on a particular deployment and use case scenario.

Each retractor of a respective motion assembly includes a winding core 626 configured to release and retract a belt 628. For example, the first motion assembly 622a and the second motion assembly 622k, each include an outer retractor and an inner retractor. The outer retractors releases and retracts the belt 628 on a bottom surface of the base plinth 610 (underneath) and the inner retractors release and retract the belt 628 on a top surface of the base plinth 610 (above the top surface of the base plinth 610). The belt 628 of the outer retractor goes underneath the base plinth 610 and into the slots 616a-j to latch onto the PRM device from the front.

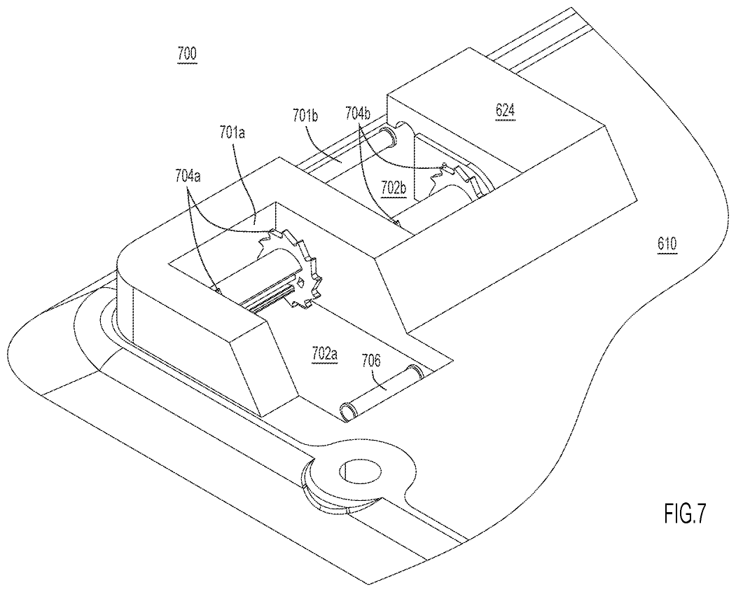

With continued reference to FIG. 6, FIG. 7 is a diagram illustrating a motion assembly 700 of the latching mechanism 620 of FIG. 6 for securing a PRM device to the base plinth 610, according to another example embodiment. The latching mechanism 620 may include a number of motion assemblies but for the sake of simplicity only the components of the motion assembly 700 are depicted e.g., the first motion assembly 622a of FIG. 6. Other motion assemblies such as the second motion assembly 622k include similar components described with reference to the motion assembly 700.

The motion assembly 700 has a housing 624. The housing 624 may be S-shaped and include slanted edges. The motion assembly 700 includes an outer retractor 701a and an inner retractor 701b. The outer retractor 701a is configured to retract or release the belt (not shown) along the bottom surface of the base plinth 610 (underneath the base plinth 610), whereas the inner retractor 701b is configured to retract and release the belt (not shown) along the top surface of the base plinth 610 (above the base plinth 610).

Each retractor has a winding core for the respective belt. For example, the outer retractor 701a has a first winding core 702a and the inner retractor 701b has a second winding core 702b. Each belt is held in place by a pair of teethed gears i.e., a first pair of gears 704a for outer retractor 701a and a second pair of gears 704b for the inner retractor 701b. The first winding core 702a releases the belt under the base plinth 610. A guide roller 706 helps safe retraction and release of the belt and ensures that the belt goes under the base plinth 610. In yet another example embodiment, a clasp maybe used to help guide the belt to be under the base plinth 610. The belt goes into the slots 616a-j (FIG. 6) to latch onto the PRM device at the front portion thereof. The second winding core 702b is configured to release and retract the belt above the base plinth 610 such that the hooks attached to the belt latch onto latching points at the back of the PRM device.

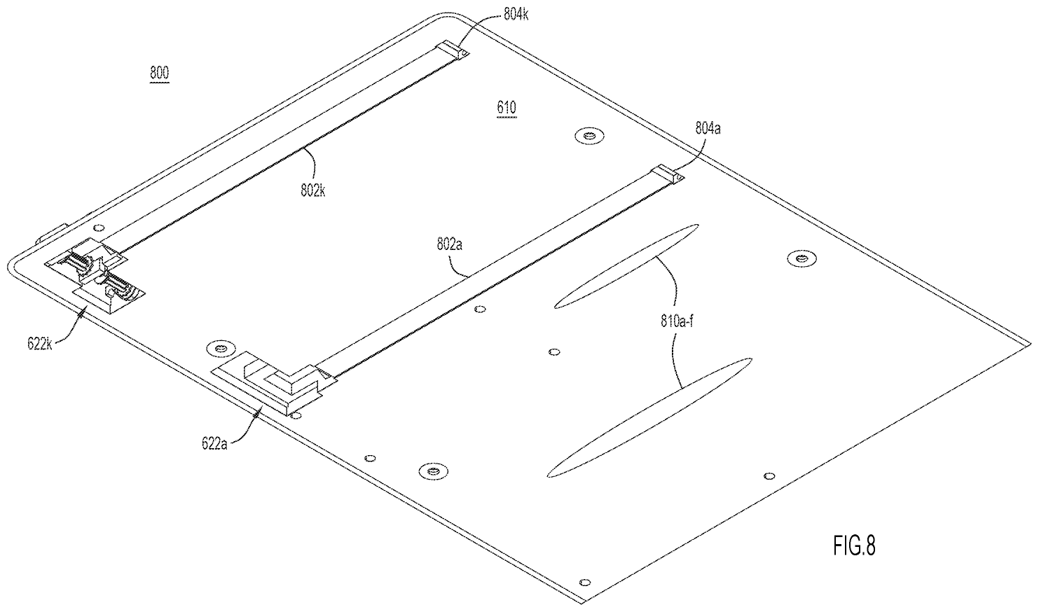

With continued reference to FIGS. 6 and 7, FIG. 8 is a diagram illustrating a bottom surface 800 of the base plinth 610 of FIG. 6 to which a PRM device is secured, according to another example embodiment. The bottom surface 800 has a first belt 802a and a second belt 802k that extended along the width of the bottom surface 800 from the first motion assembly 622a and the second motion assembly 622k of FIGS. 6 and 7 into respective belt slots such as a first belt slot 804a and a second belt slot 804k.

That is, the first belt 802a is released and retracted by an outer retractor of the first motion assembly 622a and the second belt 802k is released and retracted by an outer retractor of the second motion assembly 622k. The hooks (not shown) attached to the first belt 802a and second belt 802k exit through the first belt slot 804a and the second belt slot 804k to latch onto the PRM device on a top surface of the base plinth 610 from the front. Specifically, the hooks attached to first belt 802a and the second belt 802k latch onto front latching points on the PRM device.

The bottom surface 800 includes one or more track fittings 810a-f to attach the base plinth 610 to seat tracks of an aircraft in one example embodiment. In other example embodiments, the bottom surface 800 may be attached to a frame of the bus or another vehicle (e.g., amusement ride cart), or a floor in a seating place.

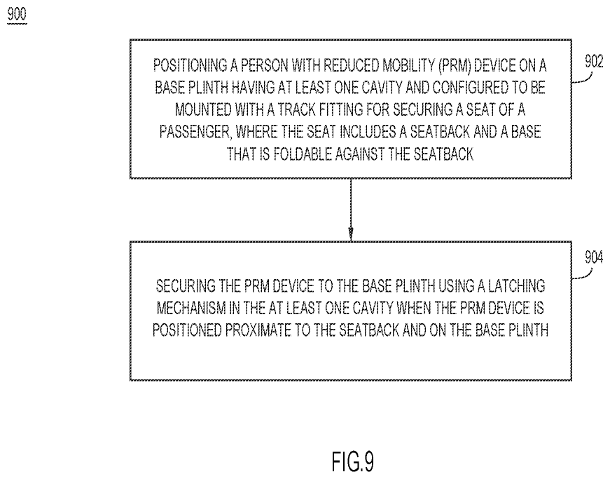

FIG. 9 is a flowchart illustrating a method 900 of securing a PRM device in a seating area, according to an example embodiment.

The method 900 involves, at 902, positioning the PRM device on a base plinth having at least one cavity and configured to be mounted with a track fitting for securing a seat of a passenger. The seat includes a seatback and a base that is foldable against the seatback.

The method 900 further involves, at 904, securing the PRM device to the base plinth using a latching mechanism in the at least one cavity when the PRM device is positioned proximate to the seatback and on the base plinth.

In one form, the method 900 may further involve releasing a lock to fold the base of the seat against the seatback of the seat.

In another form, the method 900 may further involve detecting the PRM device being placed on a metal plate that is securely attached to the base plinth and that covers at least a portion of the at least one cavity. The method 900 may further involve releasing, via a plurality of motion assemblies, a plurality of mounting hooks, each configured to attach to a respective latching point on the PRM device when the PRM device is detected to be positioned fully within the metal plate. The method 900 may further involve retracting, via the plurality of motion assemblies, the plurality of mounting hooks. Each mounting hook is retracted to a predetermined tension point after being latched onto the PRM device at the respective latching point.

According to one or more example embodiments, the method 900 may further involve controlling the at least two motion assemblies to synchronously move each of the at least two mounting hooks towards the respective latching point on the PRM device.

In one instance, the method 900 may further involve controlling a release lever to be pushed into an unlocked position. The method 900 may further involve, based on the unlocked position, causing pivoting of a core of a spring-loaded winding having a belt or a cable wound around the core such that a respective hook attached to the spring-loaded winding extends towards the respective latching point on the PRM device. The method 900 may further involve controlling the release lever to be released into a locked position. The method 900 may further involve, based on the locked position, retracting the spring-loaded winding to a predetermined tension point in which the respective mounting hook is latched onto the respective latching point on the PRM device to secure the PRM device to the base plinth.

In another instance, the method 900 may further involve, based on detecting a change in the predetermined tension point, causing the core to pivot and wind the belt or cable around the core such that the respective mounting hook is retracted into the at least one cavity. The change in the predetermined tension point may be indicative of the respective mounting hook being detached from the PRM device.

According to one or more example embodiments, the method 900 may further involve independently adjusting, via a respective motion assembly, each of the at least two hooks to accommodate different types of PRM devices.

In another example embodiment, a securing apparatus is provided. The securing apparatus includes a base plinth and a latching mechanism. The base plinth has at least one cavity and configured to be mounted with a track fitting for securing at least one seat thereon. The at least one seat includes a seatback and a base that is foldable against the seatback to accommodate a person with reduced mobility (PRM) device. The latching mechanism in the at least one cavity of the base plinth and configured to secure the PRM device to the base plinth when the PRM device is positioned proximate to the seatback and on the base plinth.

In one form, the at least one cavity may include a plurality of seat leg cavities that accommodate a plurality of seat legs of the at least one seat.

In one instance, the plurality of seat leg cavities may be configured to secure the plurality of seat legs of a single aircraft seat.

In another instance, the base plinth may be configured to span a plurality of passenger seats in an aircraft and may include the plurality of seat leg cavities for securing the plurality of passenger seats to the track fitting.

According to one or more example embodiments, the at least one seat may be configured to accommodate a passenger in a vehicle in a first position in which the base is unfolded and to accommodate the PRM device in the vehicle in a second position in which the base is folded against the seatback to allow the PRM device to be secured to the base plinth using the latching mechanism.

In another form, the securing apparatus may further include a metal plate that is securely attached to the base plinth and configured to cover a portion of the at least one cavity, and over which the PRM device is positioned when the PRM device is positioned proximate to the seatback.

According to one or more example embodiments, the latching mechanism may include at least two mounting hooks. Each mounting hook may be configured to attach to a respective latching point on the PRM device when the PRM device is positioned on the metal plate and proximate to the seatback. The latching mechanism may further include at least two motion assemblies. Each motion assembly may be configured to release and retract a respective mounting hook.

In one instance, the latching mechanism may further include an actuator configured to control the at least two motion assemblies to synchronously move each of the at least two mounting hooks towards the respective latching point on the PRM device.

In another instance, the latching mechanism may further include an actuation component configured to control the at least two motion assemblies to release or retract the at least two mounting hooks. The actuation component may be positioned on the base plinth such that an activation occurs when the PRM device is placed fully on the metal plate.

According to one or more example embodiments, the at least one cavity may include a plurality of cavities. Each cavity may be configured to stow a respective motion assembly of the at least two motion assemblies.

In one or more example embodiments, each of the at least two motion assemblies may include a spring-loaded winding having a belt or a cable wound around a core and a release lever. The spring-loaded winding may be nested within the at least one cavity. The release lever may be configured to be pushed into an unlocked position in which the core pivots such that the spring-loaded winding extends towards the respective latching point on the PRM device. The release lever may further be configured to be released into a locked position in which the spring-loaded winding is retracted to a predetermined tension point in which the respective mounting hook is latched onto the respective latching point on the PRM device to secure the PRM device to the base plinth.

In another instance, the at least two mounting hooks may include a plurality of mounting hooks. Each mounting hook may be positioned at a respective corner of the base plinth and may be independently adjustable via a respective motion assembly to accommodate different types of PRM devices.

In one form, the at least two mounting hooks and the at least two motion assemblies may be configured to be stowed in the at least one cavity. The metal plate may cover the at least two motion assemblies.

In yet another example embodiment, a seat securing apparatus is provided. The seat securing apparatus includes a seat having at least one leg, a seatback, and a base that is foldable against the seatback to accommodate a person with reduced mobility (PRM) device. The seat securing apparatus further includes a base plinth and a latching mechanism. The base plinth has at least one first cavity configured to accommodate the at least one leg of the seat and at least one second cavity. The latching mechanism is placed at the at least one second cavity. The latching mechanism is configured to secure the PRM device to the base plinth when the PRM device is positioned proximate to the seatback and on the base plinth.

In one form, the seat may be configured to accommodate a passenger in a vehicle in a first position in which the base is unfolded. The seat may further be configured to accommodate the PRM device in the vehicle in a second position in which the base is folded against the seatback to allow the PRM device to be secured to the base plinth using the latching mechanism.

In one instance, the base plinth may be configured to accommodate a single aircraft seat.

In another instance, the base plinth may be configured to span a plurality of passenger seats in an aircraft and may include a plurality of first cavities for securing the plurality of passenger seats to a seat track fitting in the aircraft.

According to one or more example embodiments, the seat securing apparatus may further include a metal plate securely attached to the base plinth and configured to cover a portion of the at least one second cavity. The PRM device may be positioned on the metal plate when the PRM device is positioned proximate to the seatback.

In one instance, the latching mechanism may protrude from the at least one second cavity. The at least one second cavity is positioned near or proximate to an edge of the base plinth.

In yet another example embodiment, a system is provided that includes the apparatuses and operations explained above with reference to FIGS. 1-9.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Accordingly, the appended claims should be construed broadly and, in a manner, consistent with the scope of the present disclosure.

What is claimed is:

1. A securing apparatus comprising:
a base plinth having at least one cavity and configured to be mounted with a track fitting for securing at least one seat thereon, wherein the at least one seat includes a seatback and a base that is foldable against the seatback to accommodate a person with reduced mobility (PRM) device; and
a latching mechanism in the at least one cavity of the base plinth and configured to secure the PRM device to the base plinth when the PRM device is positioned proximate to the seatback and on the base plinth.

2. The securing apparatus of claim 1, wherein the at least one cavity comprises a plurality of seat leg cavities that accommodate a plurality of seat legs of the at least one seat.

3. The securing apparatus of claim 2, wherein the plurality of seat leg cavities are configured to secure the plurality of seat legs of a single aircraft seat.

4. The securing apparatus of claim 2, wherein the base plinth is configured to span a plurality of passenger seats in an aircraft and includes the plurality of seat leg cavities for securing the plurality of passenger seats to the track fitting.

5. The securing apparatus of claim 1, wherein the at least one seat is configured to accommodate a passenger in a vehicle in a first position in which the base is unfolded and to accommodate the PRM device in the vehicle in a second position in which the base is folded against the seatback to allow the PRM device to be secured to the base plinth using the latching mechanism.

6. The securing apparatus of claim 1, further comprising:
a metal plate that is securely attached to the base plinth and configured to cover a portion of the at least one cavity, and over which the PRM device is positioned when the PRM device is positioned proximate to the seatback.

7. The securing apparatus of claim 6, wherein the latching mechanism includes:
at least two mounting hooks, each of which is configured to attach to a respective latching point on the PRM device when the PRM device is positioned on the metal plate and proximate to the seatback; and
at least two motion assemblies, each of which is configured to release and retract a respective mounting hook.

8. The securing apparatus of claim 7, wherein the latching mechanism further includes:
an actuator configured to control the at least two motion assemblies to synchronously move each of the at least two mounting hooks towards the respective latching point on the PRM device.

9. The securing apparatus of claim 7, wherein the latching mechanism further includes:
an actuation component configured to control the at least two motion assemblies to release or retract the at least two mounting hooks, the actuation component positioned on the base plinth such that an activation occurs when the PRM device is placed fully on the metal plate.

10. The securing apparatus of claim 7, wherein the at least one cavity comprises a plurality of cavities, each configured to stow a respective motion assembly of the at least two motion assemblies.

11. The securing apparatus of claim 7, wherein each of the at least two motion assemblies includes:
a spring-loaded winding having a belt or a cable wound around a core, the spring-loaded winding being nested within the at least one cavity; and
a release lever configured to:
be pushed into an unlocked position in which the core pivots such that the spring-loaded winding extends towards the respective latching point on the PRM device, and
be released into a locked position in which the spring-loaded winding is retracted to a predetermined tension point in which the respective mounting hook is latched onto the respective latching point on the PRM device to secure the PRM device to the base plinth.

12. The securing apparatus of claim 7, wherein the at least two mounting hooks include a plurality of mounting hooks, each positioned at a respective corner of the base plinth and being independently adjustable via a respective motion assembly to accommodate different types of PRM devices.

13. The securing apparatus of claim 7, wherein the at least two mounting hooks and the at least two motion assemblies are configured to be stowed in the at least one cavity, and wherein the metal plate covers the at least two motion assemblies.

14. A seat securing apparatus comprising:
a seat having at least one leg, a seatback, and a base that is foldable against the seatback to accommodate a person with reduced mobility (PRM) device;
a base plinth having at least one first cavity configured to accommodate the at least one leg of the seat and at least one second cavity; and
a latching mechanism placed at the at least one second cavity and configured to secure the PRM device to the base plinth when the PRM device is positioned proximate to the seatback and on the base plinth.

15. The seat securing apparatus of claim 14, wherein the seat is configured to accommodate a passenger in a vehicle in a first position in which the base is unfolded and to accommodate the PRM device in the vehicle in a second position in which the base is folded against the seatback to allow the PRM device to be secured to the base plinth using the latching mechanism.

16. The seat securing apparatus of claim 15, wherein the base plinth is configured to accommodate a single aircraft seat.

17. The seat securing apparatus of claim 15, wherein the base plinth is configured to span a plurality of passenger seats in an aircraft and includes a plurality of first cavities for securing the plurality of passenger seats to a seat track fitting in the aircraft.

18. The seat securing apparatus of claim 14, wherein the latching mechanism protrudes from the at least one second cavity that is near or proximate to an edge of the base plinth.

19. A method comprising:
positioning a person with reduced mobility (PRM) device on a base plinth having at least one cavity and configured to be mounted with a track fitting for securing a seat of a passenger, wherein the seat includes a seatback and a base that is foldable against the seatback; and
securing the PRM device to the base plinth using a latching mechanism in the at least one cavity when the PRM device is positioned proximate to the seatback and on the base plinth.

20. The method of claim 19, further comprising:
releasing a lock to fold the base of the seat against the seatback of the seat to allow the PRM device to be positioned on the base plinth.

21. The method of claim 19, wherein securing the PRM device includes:
detecting the PRM device being placed on a metal plate that is securely attached to the base plinth and that covers at least a portion of the at least one cavity;
releasing, via a plurality of motion assemblies, a plurality of mounting hooks, each configured to attach to a respective latching point on the PRM device when the PRM device is detected to be positioned fully within the metal plate; and
retracting, via the plurality of motion assemblies, the plurality of mounting hooks, each to a predetermined tension point after being latched onto the PRM device at the respective latching point.
